(19) United States
(12) Patent Application Publication
(10) Pub. No.: US 2009/0122955 A1
(43) Pub. Date: May 14, 2009

(54) Method for the extrapolation of truncated, incomplete projections for computed tomography

(76) Inventor: Herbert Bruder, Hochstadt (DE)

Correspondence Address: HARNESS, DICKEY & PIERCE, P.L.C., P.O.BOX 8910, RESTON, VA, 20195, US

(21) Appl. No.: 12/292,127

(22) Filed: Nov. 12, 2008

(30) Foreign Application Priority Data
Nov. 13, 2007 (DE) 10 2007 054 079.7

(51) Int. Cl. H05G 1/60

(52) U.S. Cl. 378/14

(57) ABSTRACT

A method is disclosed for extrapolation of truncated, incomplete projections for computed tomography. In at least one embodiment, the method includes the following method steps. Firstly, scanning of an examination object with the aid of a beam. Secondly, detection of complete and incomplete projection data during a scan. Thirdly, the carrying out of a parallel rebinning for the detected projection data by resorting and conversion of the projection data P(α, β, q) present in fan geometry into projection data P(θ, t, q) present in parallel geometry. Fourthly, for the complete parallel projections, projectionwise determination of mth moments, at least for m=0 and m=1, the following holding for the mth moment of a parallel projection P_{θ}(t) (m=0, 1, 2, . . . ):

$$\begin{matrix}{m}_{n} ( {P}_{θ} ( t ) ) = {\int }_{- ∞}^{+ ∞} t \cdot {P}_{θ} ( t ) d t \\ = {\int }_{- ∞}^{+ ∞} {t}^{n} d t {\int }_{- ∞}^{+ ∞} {\int }_{- ∞}^{+ ∞} f ( x , y ) \cdot \\ δ ( t - {r}^{->} \cdot {{e}^{->}}_{θ} ) d x d y \\ = {\int }_{- ∞}^{+ ∞} {\int }_{- ∞}^{+ ∞} f ( x , y ) \cdot {( {r}^{->} \cdot {{e}^{->}}_{θ} )}^{n} d x d y .\end{matrix}$$

Fifthly, extrapolation of the incomplete, truncated parallel projections such that the values determined for the mth moments are also valid for the incomplete, truncated parallel projection.

### PRIORITY STATEMENT

The present application hereby claims priority under 35 U.S.C. §119 on German patent application number DE 10 2007 054 079.7 filed Nov. 13, 2007, the entire contents of which is hereby incorporated herein by reference.

### FIELD

Embodiments of the present invention generally relate to a method for the extrapolation of truncated, incomplete projections for computed tomography by utilizing consistency conditions for the measured value projections.

### BACKGROUND

Computed tomography is known as a two-stage imaging method. In this case, an examination object is transirradiated with X-rays, and the attenuation of the X-rays is detected along the path from the radiation source (X-ray source) to the detector system (X-ray detector). The attenuation is caused by the transirradiated materials along the beam path, and so the attenuation can also be understood as the line integral over the attenuation coefficients of all the volume elements (voxels) along the beam path. Detected projection data cannot be interpreted directly, that is to say they do not produce an image of the transirradiated layer of the examination object. It is only in a second step that it is possible via a reconstruction method to calculate back from the projected attenuation data to the attenuation coefficients β of the individual voxels, and thus to generate an image of the distribution of the attenuation coefficients. This enables a substantially more sensitive examination of the examination object than in the case of simple reviewing projection images.

Instead of the attenuation coefficient μ, in order to display the attenuation distribution use is generally made of a value normalized to the attenuation coefficient of water, this will be called CT number. This is calculated from an attenuation coefficient μ currently determined by measurement, the following equation being used:

$$C = 1000 * \frac{μ - {μ}_{{H}_{2} O}}{{μ}_{{H}_{2} O}} [ H U ] ,$$

with the CT number C in the Hounsfield unit [HU]. A value of C_{H}_{₂}_{O}=0 HU is yielded for water, and a value of C_{L}=−1000 HU is yielded for air. Since the two representations can be transformed into one another or an equivalent, the generally selected term of attenuation value or attenuation coefficient denotes both the attenuation coefficient μ and the CT value.

Modern X-ray computed tomography units (CT units) are used for recording, evaluating and displaying the three-dimensional attenuation distribution. Typically, a CT unit comprises a radiation source that directs a collimated, pyramidal or fan-shaped beam through the examination object, for example a patient, on to a detector system constructed from a number of detector elements. Depending on the design of the CT unit, the radiation source and the detector system are fitted, for example, on a gantry or a C-arm that can be rotated about a system axis (z-axis) by an angle α. Also provided is a support device for the examination object that can be displaced or moved along the system axis (z-axis).

During the recording, each detector element of the detector system that is struck by the radiation produces a signal which constitutes a measure of the total transparency of the examination object for the radiation emanating from the radiation source on its way to the detector system or the corresponding radiation attenuation. The set of output signals of the detector elements of the detector system that is obtained for a specific position of the radiation source is denoted as projection. The position emanating from which the beam penetrates the examination object is continuously varied as a consequence of the rotation of the gantry/C-arm. In this case, a scan comprises a multiplicity of projections that are obtained at various positions of the gantry/C-arm, and/or the various positions of the support device. A distinction is made here between sequential scanning methods (axial scan operation) and spiral scan methods.

As specified above, a two-dimensional slice image of a layer of the examination object is reconstructed on the basis of the data record generated in the scan. The quantity and quality of the measured data detected during a scan depend on the detector system used. A number of layers can be recorded simultaneously with the aid of a detector system that comprises an array composed of a number of rows and columns of detector elements. Detector systems with 256 or more rows are currently known.

Problems in the reconstruction of the projection data arise whenever the geometry of the examination object projects beyond the detector measurement field for at least some projection angles during the above-described detection of the projection data. In these cases, the projection data detected in the transirradiation of the examination object are truncated, that is to say incomplete, and this leads to image artifacts in the reconstruction. In order, nevertheless, to enable as accurate as possible an image reconstruction, there is a need for appropriate extrapolations before the reconstruction for the truncated, incomplete projections.

### SUMMARY

In at least one embodiment of the invention, a method is specified for the extrapolation of truncated, incomplete projections for computed tomography.

### BRIEF DESCRIPTION OF THE DRAWINGS

Further advantages, features and properties of the present invention are explained below in more detail with the aid of exemplary example embodiments and with reference to the accompanying drawings, in which:

FIG. 1 shows an example embodiment of the inventive method;

FIG. 2 illustrates geometric conditions for an example embodiment;

A projection in parallel beam geometry is illustrated in FIG. 3; and

FIG. 4 shows measured output data of a truncated parallelized projection for the projection angle θ.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

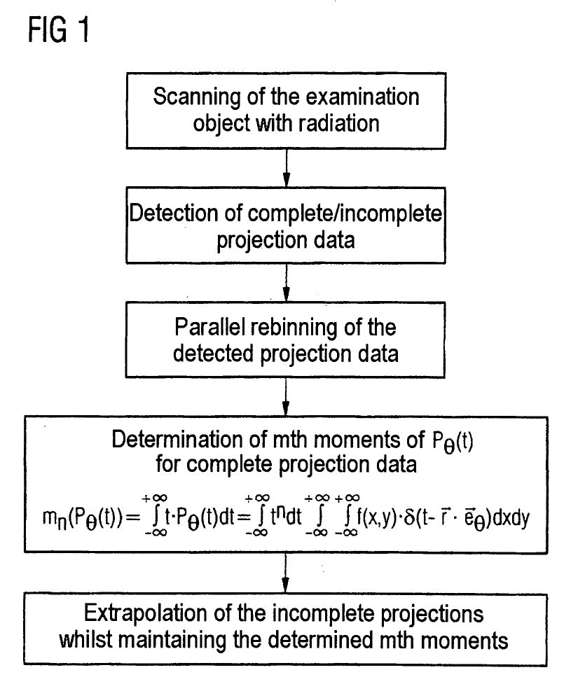

The inventive method of an embodiment for the extrapolation of truncated, incomplete projections for computed tomography has the following five method steps (compare FIG. 1).

Firstly, scanning an examination object with the aid of a conical beam emanating from at least one focus and having an aperture angle (2β₀), and of a detector array with detector elements, arranged in at least one detector row and a number of detector columns, for detecting the beam, in which case the at least one focus is rotated about a system axis relative to the examination object on at least one focal path running around the examination object, and the detector elements of the detector array supply projection data that represent the attenuation of the rays upon passage through the examination object.

Secondly, during a scan, that is to say during at least one 180° revolution of the focus, detection of complete projections in the case of which a lateral extent of the examination object is completely detected by the beam, and/or by the detector array and of incomplete, truncated projections in the case of which the lateral extent of the examination object is not detected, or detected incompletely by the beam and/or by the detector array.

Thirdly, parallel rebinning of the detected projection data by resorting and conversion of the projection data P(α, β, q) present in fan geometry into projection data P(θ, t, q) present in parallel geometry, in which case α is the focus angle, β is the fan angle, q is the row index, corresponding to the z-coordinate, of the detector array, θ=α+β is the parallel fan angle, t=R_{F}*sin(β) is the parallel coordinate corresponding to the beam spacing from the axis of rotation (system axis), R_{F} is the radius of the focal path. Moreover, it holds for the z-coordinate of a layer q of a parallel projection in parallel geometry with reference to a detector center that

$$z = ( q - \frac{{N}_{q}}{2} ) \cdot S + η ; {S}^{->} = S \cdot \sqrt{1 - {( \frac{t}{{R}_{f}} )}^{2}} ; η = {z}_{rot} \cdot a sin ( \frac{t}{{R}_{f}} ) / ( 2 π ) ,$$

where Zᵣₒₜ is the z-feed per revolution in spiral operation, and N_{q} is the number of detector rows.

Fourthly, for the complete parallel projections, projectionwise determination of mth moments, at least for m=0 and m=1, the following holding for the mth moment of a parallel projection P_{θ}(t) (m=0, 1, 2, . . . ):

$$\begin{matrix}\begin{matrix}{m}_{n} ( {P}_{θ} ( t ) ) = {\int }_{- ∞}^{+ ∞} t \cdot {P}_{θ} ( t ) d t \\ = {\int }_{- ∞}^{+ ∞} {t}^{n} d t {\int }_{- ∞}^{+ ∞} {\int }_{- ∞}^{+ ∞} f ( x , y ) \cdot \\ δ ( t - {r}^{->} \cdot {{e}^{->}}_{θ} ) d x d y\end{matrix} & ( 1 ) \\ = {\int }_{- ∞}^{+ ∞} {\int }_{- ∞}^{+ ∞} f ( x , y ) \cdot {( {r}^{->} \cdot {{e}^{->}}_{θ} )}^{n} d x d y , & ( 2 )\end{matrix}$$

the 0th moment corresponding to the attenuation mass:

$${m}_{0} ( {P}_{θ} ( t ) ) = {\int }_{- ∞}^{+ ∞} {P}_{θ} ( t ) d t = {\int }_{- ∞}^{+ ∞} {\int }_{- ∞}^{+ ∞} f ( x , y ) d x d y , \qquad ( 3 )$$

a linear combination, dependent on the projection angle, of the centroid of the attenuation mass m₀ in the x- and y-directions corresponding for the 1th moment:

$$\begin{matrix}\begin{matrix}{m}_{1} ( {P}_{θ} ( t ) ) = \frac{1}{m ( {P}_{θ} ( t ) )} {\int }_{- ∞}^{+ ∞} t \cdot {P}_{θ} ( t ) d t \\ = \frac{1}{{m}_{0}} {\int }_{- ∞}^{+ ∞} {\int }_{- ∞}^{+ ∞} f ( x , y ) \cdot ( {r}^{->} \cdot {{e}^{->}}_{θ} ) d x d y ,\end{matrix} & ( 4 ) \\ {m}_{x} = \frac{1}{{m}_{0}} {\int }_{- ∞}^{+ ∞} {\int }_{- ∞}^{+ ∞} ( {f ( x , y )}^{*} x ) d x d y , and & ( 5 ) \\ {m}_{y} = \frac{1}{{m}_{0}} {\int }_{- ∞}^{+ ∞} {\int }_{- ∞}^{+ ∞} ( {f ( x , y )}^{*} y ) d x d y . & ( 6 )\end{matrix}$$

Fifthly, extrapolation of the incomplete, truncated parallel projections such that the values determined for the mth moments are also valid for the extrapolated incomplete, truncated parallel projections.

The inventive method of at least one embodiment enables the extrapolation of truncated, incomplete projections that are detected by CT units with single-row or multi-row detector arrays that are operated in axial or spiral operation. The inventive method of at least one embodiment is based in this case on the fundamental idea of using the completely detected projections to determine consistency conditions and using the latter as a basis for the extrapolation of incomplete, truncated projections.

The aim below is firstly to consider the method of at least one embodiment for the two-dimensional case, that is to say the recording of projections in axial operation (serial scan operation; z=constant). It may be assumed here that during recording of the projections the examination object projects over the field of view (FOV)—still to be defined below—of the CT unit.

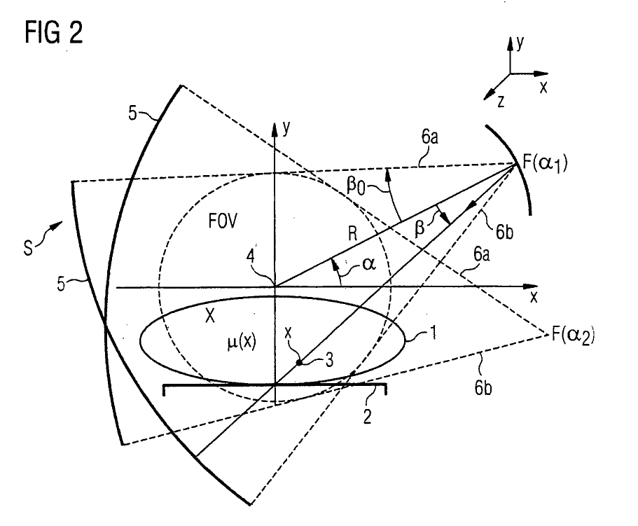

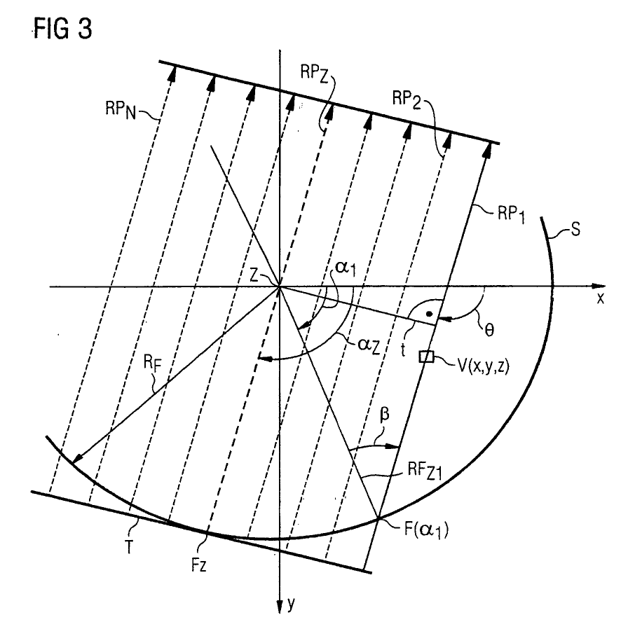

FIG. 2 illustrates the geometric conditions for this case. FIG. 2 is schematic of a section through an examination object 1 in the plane of rotation of the focus F (z=constant). The basic Cartesian coordinate system is formed by the x- and y-axes lying in the plane of the image, and by the z-axis, which is perpendicular to the plane of the image and corresponds to the axis of symmetry 4 of the CT unit. Arranged situated opposite the focus F that can rotate about the axis of symmetry 4 is a single-row detector array 5 that also rotates with the focus F. Emanating from the focus F is a beam with an aperture angle 2β₀ that strikes the detector array 5. The beam is bounded by the outer marginal rays 6a and 6b. The region that lies for all focal positions F(α) between the marginal rays 6a and 6b is denoted as the “field of view” of the CT unit. The region outside the field of view is denoted as “extended field of view”.

Moreover, the geometric conditions regarding the projection of the examination object 1 for two different focal positions F(α₁) and F(α₂) can be gathered from FIG. 2. In both cases, in addition to the focal positions the beams emanating from the focus are each specified by their marginal rays 6a and 6b, and the associated detector positions are specified. It is clearly to be seen that for the focal position F(α₂) the entire circumferential line of the cross section of the examination object is detected by the projection, and thus that a complete projection of the examination object 1 is generated, as in the focal position F(α₁) the right hand part of the examination object projects over the beam, or the detector array, the result being a truncated, incomplete projection of the examination object 1.

In the present example embodiment, both complete and truncated, incomplete projections are detected during scanning of the examination object. The projection data obtained in this case are firstly present in fan beam geometry in the form of rays P(α, β, q). Here, α corresponds to the focal angle, β to the fan angle and q to the row index of the detector system that corresponds to the z-coordinate. Although it is possible in principle for the inventive method also to be executed in fan beam geometry, the method is implemented here in parallel beam geometry.

In the third method step, the projection data detected in fan beam geometry during scanning of the examination objects are therefore converted into data in parallel beam geometry in a way known per se by a method denoted in general as rebinning. This conversion is based on a resorting of the projection data obtained in fan beam geometry in such a way that beams are extracted from different projections recorded in fan beam geometry and combined to form a projection in parallel geometry. In parallel beam geometry, data from one interval of length Π suffice to be able to reconstruct a complete image.

In order to obtain these data, it is necessary nevertheless for data in fan beam geometry to be available for an interval of length of Π+2β₀.

A projection in parallel beam geometry is illustrated in FIG. 3. According to this, all n parallel beams RP1 to RPN of this projection adopt the parallel angle θ to the x-axis of the coordinate system illustrated in FIG. 3 and corresponding to that in accordance with FIG. 2.

The aim below is to use the parallel beam RP₁ illustrated by a continuous line in FIG. 3 in order to explain the transition from fan beam geometry to parallel beam geometry. The parallel beam RP₁ stems from the projection obtained in fan beam geometry for the focal position F(α₁) lying on the focal paths. The central beam RF_{z1} belonging to this projection in fan beam geometry and running through the z-axis of the coordinate system is likewise plotted in FIG. 3. The focal position F(α₁) corresponds to the focal angle α₁. This is the angle enclosed by the x-axis and the central beam RF_{z1}. The beam RP₁ has the fan angle β in comparison to the central beam RF_{z1}.

It is therefore easy to recognize that θ=α+holds β for the parallel fan angle θ. The beam spacing t, measured at right angles to the respective parallel beam, from the z-axis is given by t=R_{f}*sin(β). As becomes clear with the aid of the central beam RP_{z} that is represented by a bold line in FIG. 3 and runs through the z-axis and/or the x-axis, this beam is the central beam of a projection in fan beam geometry that is recorded in fan geometry for the focal position F_{z} at the focal angle α_{z}. Since it holds that β=0 for the central beam of a projection recorded in fan beam geometry, it is made clear that the following holds for the case of central beams: depending on whether an azimuthal or complete rebinning is carried out, the parallel projections are present in the form P(α, β, q) or in the form P(θ, t, q).

At the end of third method step, that is to say after the rebinning of the measured projection data, the projection data are present as a two-dimensional or three-dimensional parallel sonogram P(θ, t) and P(θ, t, q) respectively.

In the fourth method step, consistency conditions are determined for the measured projections. To this end, for the complete parallel projections, projectionwise determination of mth moments, at least for m=0 and m=1, the following holding for the mth moment of a parallel projection P_{θ}(t) (m=0, 1, 2, . . . ):

$$\begin{matrix}{m}_{n} ( {P}_{θ} ( t ) ) = {\int }_{- ∞}^{+ ∞} t \cdot {P}_{θ} ( t ) d t \\ = {\int }_{- ∞}^{+ ∞} {t}^{n} d t {\int }_{- ∞}^{+ ∞} {\int }_{- ∞}^{+ ∞} f ( x , y ) \cdot \\ δ ( t - {r}^{->} \cdot {{e}^{->}}_{θ} ) d x d y \\ = {\int }_{- ∞}^{+ ∞} {\int }_{- ∞}^{+ ∞} f ( x , y ) \cdot {( {r}^{->} \cdot {{e}^{->}}_{θ} )}^{n} d x d y .\end{matrix}$$

It was recognized that the 0th moment corresponds to a complete, that is to say not truncated, parallel projection P_{θ}(t) of the entire attenuation mass of a detected layer of the examination object.

$${m}_{0} ( {P}_{θ} ( t ) ) = {\int }_{- ∞}^{+ ∞} {P}_{θ} ( t ) d t = {\int }_{- ∞}^{+ ∞} {\int }_{- ∞}^{+ ∞} f ( x , y ) d x d y ,$$

It was recognized, furthermore, that the 1th moment can be interpreted as a linear combination, dependent on the projection angle θ, of the centroid of the attenuation mass in the x- and y-directions, respectively. Both the total attenuation mass m₀ and the centroid in the x- and y-directions (mₓ and m_{y}) are values that are equal for all complete projections within the scope of the measuring accuracy. Thus, if these values are determined for the complete projections, the truncated, incomplete projections can be extrapolated in such a way that the values also hold for the extrapolated truncated, incomplete projections.

An extrapolation of the incomplete, truncated parallel projections is therefore carried out in the fifth method step such that the values (consistency condition), in particular m₀, mₓ and m_{y} determined for the mth moments are also valid for the incomplete, truncated parallel projection.

For the incomplete, truncated projections, extrapolation is preferably performed with the functions of variable length, for example cos functions. The extrapolation length results in this case from the consistency conditions previously determined in the fourth method step.

The mode of procedure is explained by way of example by using cos functions. In this case, m₀ or m₁ is determined as:

$$\begin{matrix}{m}_{0} = {\int }_{- ∞}^{+ ∞} {P}_{θ} ( t ) d t \\ = {\int }_{{t}_{l , θ}}^{{t}_{r , θ}} {P}_{θ} ( t ) d t + {\int }_{{t}_{trl}}^{{t}_{l , θ}} {A}_{l} \cdot ( 1 - cos ( \frac{π}{2} \cdot \frac{t - {t}_{l , θ}}{\vert {t}_{l , θ} - {t}_{trl} \vert} ) ) + \\ {\int }_{{t}_{r , θ}}^{{t}_{trr}} {A}_{r} \cdot cos ( \frac{π}{2} \cdot \frac{{t}_{r , θ} - t}{\vert {t}_{r , θ} - {t}_{trr} \vert} )\end{matrix} \qquad ( 7 )$$

and, respectively,

$$\begin{matrix} {m}_{1} ( θ ) = \frac{1}{{m}_{0}} \cdot {\int }_{- ∞}^{+ ∞} t \cdot {P}_{θ} ( t ) d t & ( 8 ) \\ = \frac{1}{{m}_{0}} \cdot {\int }_{{t}_{l , θ}}^{{t}_{r , θ}} t \cdot {P}_{θ} ( t ) d t + {\int }_{{t}_{trl}}^{{t}_{l , θ}} {A}_{l} \cdot t \cdot ( 1 - cos ( \frac{π}{2} \cdot \frac{t - {t}_{l , θ}}{\vert {t}_{l , θ} - {t}_{trl} \vert} ) ) + {\int }_{{t}_{r , θ}}^{{t}_{trr}} {A}_{r} \cdot t \cdot cos ( \frac{π}{2} \cdot \frac{{t}_{r , θ} - t}{\vert {t}_{r , θ} - {t}_{trr} \vert} ) . {\int }_{{t}_{l , θ}}^{{t}_{r , θ}} {P}_{θ} ( t ) d t and {\int }_{{t}_{l , θ}}^{{t}_{r , θ}} t \cdot {P}_{θ} ( t ) d t & ( 9 )\end{matrix}$$

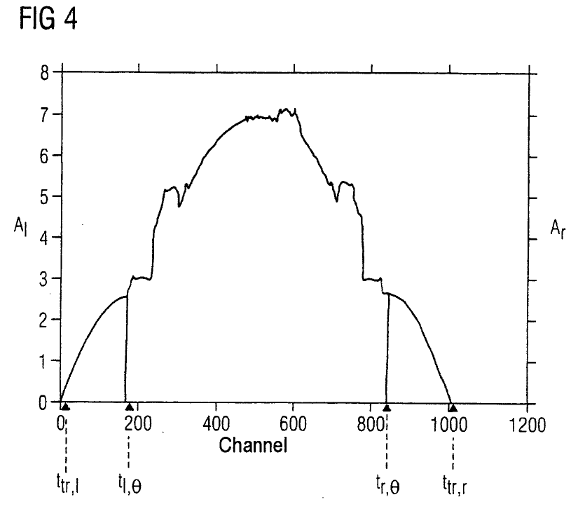

are to be determined in the projections of the truncated, incomplete projections. The parameters tₜᵣ_{_{—}}₁, t_{1,θ} t_{r,θ} and tₜᵣ_{_{—}}ᵣ are determined in accordance with FIG. 4. FIG. 4 shows measured output data of a truncated parallelized projection for the projection angle θ. The measured output data are truncated for the channel values (channel) t_{1,θ}=180 and t_{r,θ}=820. The extrapolation is performed up to the values tₜᵣ_{_{—}}₁ and tₜᵣ_{_{—}}ᵣ. This yields a simple system of equations with which the required extrapolation lengths can be determined.

In the general case of multilayer CT, that is to say when use is made of detector arrays with a number of rows, it is possible to find for an axial scan a simple extension of the previously discussed method in which mean values of the columns of all the detector rows are determined in order to determine the 0th and 1th moment, and are used as an approximation for all the other detector rows. Present day multilayer detector CT units typically have a cone aperture angle of approximately 2° for the beam, and so this approximation is well suited.

The following advantageous development of the method of at least one embodiment is proposed for spiral operation of a CT unit. In spiral operation, equations (3-(6) are no longer exactly valid, since the attenuation masses m₀, mₓ and m_{y} are dependent on the projection angle θ=θ(z), which is a function of z, and so the attenuation mass and also the first moments can change in an axial direction.

Two method variants are advantageously proposed for the application of the method to spiral operation of a CT unit.

### Method A:

The change in the values m₀, mₓ and m_{y}, which depend on the projection angle θ(z), is generally small in a scanning range per revolution given a feed rate that is not excessively high, that is to say a relative speed of gantry and examination object in the z-direction which is not excessively high, and a low detector height, and is therefore regarded approximately as being constant. It is preferred to use a half revolution (complete revolution) data record that is centered in the considered projection angle θ (\hat{θ} where \hat{θ}∉[θ−π/2; θ+π/2] or \hat{θ}∉[θ−π; θ+π]) in order to determine m₀, mₓ and m_{y}. In this case, the calculation can be performed by averaging all the detector rows. Alternatively, it is also possible to use only the central detector row in each case.

### Method B:

Use is likewise made of a half revolution (complete revolution) data record that is centered in the considered projection angle θ in order to determine m₀, mₓ and m_{y}. For the projection angle \hat{θ} where \hat{θ}∉[θ−π/2; θ+π/2] or \hat{θ}∉[θ−π; θ+π], the detector row that is at the smallest spacing from z(θ) at the center of rotation (z-axis) is used in order to determine m₀, mₓ and m_{y}. This consideration can even be extended to all \hat{θ} for which at least one detector row is at a maximum spacing δ=z(\hat{θ})−z(\hat{θ}) from z(θ) at the center of rotation.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for extrapolating truncated, incomplete projections for computed tomography, the method comprising:
scanning an examination object with the aid of a conical beam emanating from at least one focus and having an aperture angle, and with the aid of a detector array with detector elements, arranged in at least one detector row and a number of detector columns, for detecting the beam, the at least one focus being rotated about a system axis relative to the examination object on at least one focal path running around the examination object, and the detector elements of the detector array being useable to supply projection data that represent the attenuation of the rays upon passage through the examination object,
detecting, during a scan, complete projections in the case of which a lateral extent of the examination object is completely detected by the beam, and detecting incomplete, truncated projections in the case of which the lateral extent of the examination object is at least one of not detected and detected in completely,
rebinning, in parallel, the detected projection data by researching and conversion of the projection data P(α, β, q) present in fan geometry into projection data P(θ, t, q) present in parallel geometry, wherein
α is the focus angle,
β is the fan angle,
q is the row index, corresponding to the z-coordinate, of the detector array,
θ=α+β is the parallel fan angle,
t=R_{F}*sin(β) is the parallel coordinate corresponding to the beam spacing from the axis of rotation (system axis), and
RF is the radius of the focal path,
determining projectionwise, for the complete parallel projections, mth moments, at least for m=0 and m=1, the following holding for the mth moment of a parallel projection P_{θ}(t) (m=0, 1, 2, . . . ):
$$\begin{matrix}{m}_{n} ( {P}_{θ} ( t ) ) = {\int }_{- ∞}^{+ ∞} t \cdot {P}_{θ} ( t ) d t \\ = {\int }_{- ∞}^{+ ∞} {t}^{n} d t {\int }_{- ∞}^{+ ∞} {\int }_{- ∞}^{+ ∞} f ( x , y ) \cdot \\ δ ( t - {r}^{->} \cdot {{e}^{->}}_{θ} ) d x d y \\ = {\int }_{- ∞}^{+ ∞} {\int }_{- ∞}^{+ ∞} f ( x , y ) \cdot {( {r}^{->} \cdot {{e}^{->}}_{θ} )}^{n} d x d y\end{matrix}$$
the 0th moment corresponding to the attenuation mass:
$${m}_{0} ( {P}_{θ} ( t ) ) = {\int }_{- ∞}^{+ ∞} {P}_{θ} ( t ) d t = {\int }_{- ∞}^{+ ∞} {\int }_{- ∞}^{+ ∞} f ( x , y ) d x d y ,$$
a linear combination, dependent on the projection angle, of the centroid of the attenuation mass in the x- and y-directions corresponding for the 1st moment:
$$\begin{matrix}\begin{matrix}{m}_{1} ( {P}_{θ} ( t ) ) = \frac{1}{m ( {P}_{θ} ( t ) )} {\int }_{- ∞}^{+ ∞} t \cdot {P}_{θ} ( t ) d t \\ = \frac{1}{{m}_{0}} {\int }_{- ∞}^{+ ∞} {\int }_{- ∞}^{+ ∞} f ( x , y ) \cdot ( {r}^{->} \cdot {{e}^{->}}_{θ} ) d x d y ,\end{matrix} \\ {m}_{x} = \frac{1}{{m}_{0}} {\int }_{- ∞}^{+ ∞} {\int }_{- ∞}^{+ ∞} ( {f ( x , y )}^{*} x ) d x d y , \\ {m}_{y} = \frac{1}{{m}_{0}} {\int }_{- ∞}^{+ ∞} {\int }_{- ∞}^{+ ∞} ( {f ( x , y )}^{*} y ) d x d y , and\end{matrix}$$
extrapolating the incomplete, truncated parallel projections such that the values determined for the mth moments are maintained for the incomplete, truncated parallel projection.

2. The method as claimed in claim 1, wherein the extrapolation of the incomplete, truncated parallel projections is performed with functions of variable length.

3. The method as claimed in claim 1, wherein a single-row detector array is used, and wherein scanning is performed in the axial operation.

4. The method as claimed in claim 1, wherein a multi-row detector array is used, and wherein the scanning is performed in axial operation.

5. The method as claimed in claim 4, wherein columnwise mean values of the projection data of the detector array are determined in order to determine the 0th and 1th moments.

6. The method as claimed in claim 4, wherein only projection data of a middle detector row of the detector array are used in order to determine the 0th and 1th moments.

7. The method as claimed in claim 1, wherein the scanning is performed in spiral operation.

8. The method as claimed in claim 7, wherein, in order to determine m₀, mₓ and m_{y}, use is made of projection data of a complete revolution or half revolution of the focus around the examination object that are centered in a considered projection angle \hat{θ} where \hat{θ}∉[θ−π/2; θ+π/2] or \hat{θ}∉[θ−π; θ+π].

9. The method as claimed in claim 8, wherein columnwise mean values of the projection data of the detector array are used in order to determine m₀, mₓ and m_{y}.

10. The method as claimed in claim 8, wherein only projection data of a middle detector row of the detector array are used in order to determine m₀, mₓ and m_{y}.

11. The method as claimed in claim 8, wherein, in order to determine m₀, mₓ and m_{y}, use is made of projection data of a detector row of the detector array that has a minimum spacing δ=z(\hat{θ})−z(θ) from the system axis.

12. The method as claimed in claim 8, wherein use is made of projection data of a detector row of the detector array that has a maximum spacing δ=z(\hat{θ})−z(θ) from the system axis in order to determine m₀, mₓ and m_{y}.

13. The method as claimed in claim 2, wherein the functions of variable length include cosign functions.

14. The method as claimed in claim 2, wherein a single-row detector array is used, and wherein scanning is performed in the axial operation.

15. The method as claimed in claim 2, wherein a multi-row detector array is used, and wherein the scanning is performed in axial operation.

16. The method as claimed in claim 15, wherein columnwise mean values of the projection data of the detector array are determined in order to determine the 0th and 1th moments.

17. The method as claimed in claim 15, wherein only projection data of a middle detector row of the detector array are used in order to determine the 0th and 1th moments.

18. The method as claimed in claim 2, wherein the scanning is performed in spiral operation.

19. The method as claimed in claim 18, wherein, in order to determine m₀, mₓ and m_{y}, use is made of projection data of a complete revolution or half revolution of the focus around the examination object that are centered in a considered projection angle \hat{θ} where \hat{θ}∉[θ−π/2; θ+π2] or \hat{θ}∉[θ−π; θ+π].

20. A computer readable medium including program segments for, when executed on a computer device, causing the computer device to implement the method of claim 1.
